(19) United States
(12) Patent Application Publication
(10) Pub. No.: US 2024/0419473 A1
(43) Pub. Date: Dec. 19, 2024

(54) COMPONENT-AGNOSTIC LICENSING ENTITLEMENT SERVICE IN A VIRTUALIZED COMPUTING SYSTEM

(71) Applicant: VMware, Inc., Palo Alto, CA (US)

(72) Inventors: Bo LIN, Beijing (CN); Caixia JIANG, Beijing (CN); Xi ZENG, Beijing (CN); Xiao LIANG, Beijing (CN); Kai LOU, Beijing (CN); Chuntao CHEN, Beijing (CN); Danyang LI, Beijing (CN); Qi WU, Beijing (CN)

(21) Appl. No.: 18/348,902

(22) Filed: Jul. 7, 2023

(30) Foreign Application Priority Data
Jun. 19, 2023 (WO) PCT/CN2023/100946

(51) Int. Cl. G06F 9/455; G06F 8/70

(52) U.S. Cl. CPC G06F 9/45558; G06F 8/70

(57) ABSTRACT

An example method of configuring an entitlement service that manages entitlement of software in a virtualized computing system includes: receiving, at a plug-in of the entitlement service, software component data that specifies a component type and offerings of the component type, the offerings associated with feature sets, the entitlement service executing on a cloud platform in the virtualized computing system; storing, by the plug-in, the software component data in a database; and notifying, by the plug-in, the entitlement service to support entitlement of components of the software having the component type.

### CROSS-REFERENCE

This application is based upon and claims the benefit of priority from International Patent Application No. PCT/CN2023/100946, filed on Jun. 19, 2023, the entire contents of which are incorporated herein by reference.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtualized infrastructure is carried out by management software that communicates with virtualization software (e.g., hypervisor) installed in the host computers.

SDDC users move through various business cycles, requiring them to expand and contract SDDC resources to meet business needs. This leads users to employ multi-cloud solutions, such as typical hybrid cloud solutions where the virtualized infrastructure supports SDDCs and “as-a-service” products that span across an on-premises data center and one or more public clouds. Running software across multiple clouds can engender complexity in setup, management, and operations. Further, there is a need for centralized control and management of software across the different clouds.

One such complexity is software licensing and product enablement. An entitlement service can execute as a cloud service (e.g., in a public cloud), which entitles software components (“components”) based on subscriptions obtained by the user. The subscriptions provide the user the software licenses and the entitlement service handles the product enablement. An entitlement service can manage entitlement for many software components distributed across the multi-cloud system (e.g., thousands or even millions of software components).

As the entitlement service is tasked to handle more and more components, and more and more component types, the entitlement service becomes more component-dependent. Each new component type has its own offerings, which enable certain feature sets, to which the user can subscribe. The entitlement service must understand the different offerings and feature sets to perform product entitlement and thus requires additional customized coding and configuration to operate with each new component type, followed by testing and integration. Accordingly, maintenance of the entitlement service can be time- and resource-intensive.

### SUMMARY

In an embodiment, a method of configuring an entitlement service that manages entitlement of software in a virtualized computing system is described. The method includes receiving, at a plug-in of the entitlement service, software component data that specifies a component type and offerings of the component type. The offerings are associated with feature sets. The entitlement service executes on a cloud platform in the virtualized computing system. The method includes storing, by the plug-in, the software component data in a database. The method includes notifying, by the plug-in, the entitlement service to support entitlement of components of the software having the component type.

In an embodiment, a method of entitling software in a virtualized computing system is described. The method includes receiving, at an entitlement service executing on a cloud platform in the virtualized computing system, an entitlement task that includes a component type and an offering of the component type. The component type is a type of component of the software. The method includes querying, by the entitlement service, a plug-in of the entitlement service with the component type and the offering to receive a feature set. The method includes entitling, by the entitlement service, a target component of the software having the component type using an entitlement specification that dictates enablement of the feature set on the target component.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a virtualized computing system according to embodiments.

FIG. 2 is a block diagram depicting logical operation of an entitlement service in a cloud platform according to embodiments.

FIG. 3 is a block diagram depicting virtualized infrastructure according to embodiments.

FIG. 4 is a flow diagram depicting a method of configuring an entitlement service that manages entitlement of software in a virtualized computing system according to embodiments.

FIG. 5 is a flow diagram depicting a method of processing a subscription to software component(s) according to embodiments.

FIG. 6 is a flow diagram depicting a method of entitling component(s) in a virtualized computing system according to embodiments.

FIG. 7 is a flow diagram depicting a method of entitlement component(s) in a virtualized computing system according to further embodiments.

### DETAILED DESCRIPTION

One or more embodiments provide a cloud platform from which various services, referred to herein as “cloud services” are delivered to software. A cloud platform comprises containers and/or virtual machines (VMs) in which software services can execute, including cloud services and other services as described herein. Cloud services are services provided from a public cloud to software that consumes the cloud services, where the software can execute in the same public cloud, in another public cloud, and/or in an on-premises environment. An “on-premises environment” comprises one or more data centers owned by a user. A public cloud comprises one or more data centers owned by a service provider. The user can be a customer of one or more service providers that operate one or more public clouds.

In an embodiment, the cloud services include an entitlement service configured to entitle software based on subscriptions obtained by the user. The subscriptions provide the user with software licenses and the entitlement service enables the target software according to the software licenses (referred to as “entitlement”). A software component (“component”) can have many features, where each feature provides some functionality. When used to entitle a target component, a subscription licenses a user for a set of features of the component, which can include all its features or some subset of its features. A provider can license a component based on different offerings, where each offering is bound to a different set of features. A virtualized computing system, such as a multi-cloud system, includes many different types of software for which a user can obtain subscriptions. A user can obtain a subscription for a component type and for an offering that is bound to a feature set. In some cases, the subscription can be further constrained to specific component(s) of the component type through component identifier(s).

In embodiments, the entitlement service is agnostic to component type, offerings for the component type, and feature sets for the offerings. The entitlement service does not require custom coding, testing, and integration as different component types fall under its management. Rather, entitlement service comprises an entitlement specification service and a plug-in. An operator supplies component data comprising a component type, its offerings, and its feature sets through an application programming interface (API) of the plugin. The plug-in stores the component data and notifies the entitlement specification service of the component type that is now supported by the entitlement service. A user interacts with the cloud platform to obtain a subscription, which identifies a component type, an offering, and component ID(s). The cloud platform generates an entitlement task for the subscription, which is received by the entitlement specification service. The entitlement specification service queries the plug-in with the component type and offering and obtains a corresponding feature set. The entitlement specification service generates an entitlement specification for enabling the feature set. The entitlement specification service supplies the entitlement specification for entitling target component(s). Embodiments of the techniques set forth herein are described below with respect to the drawings.

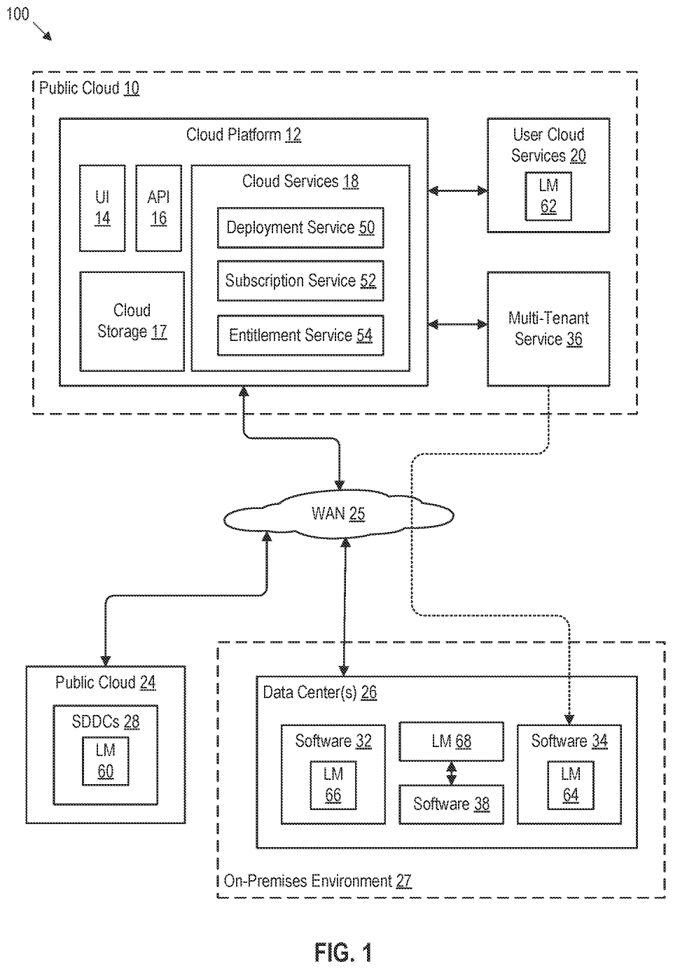

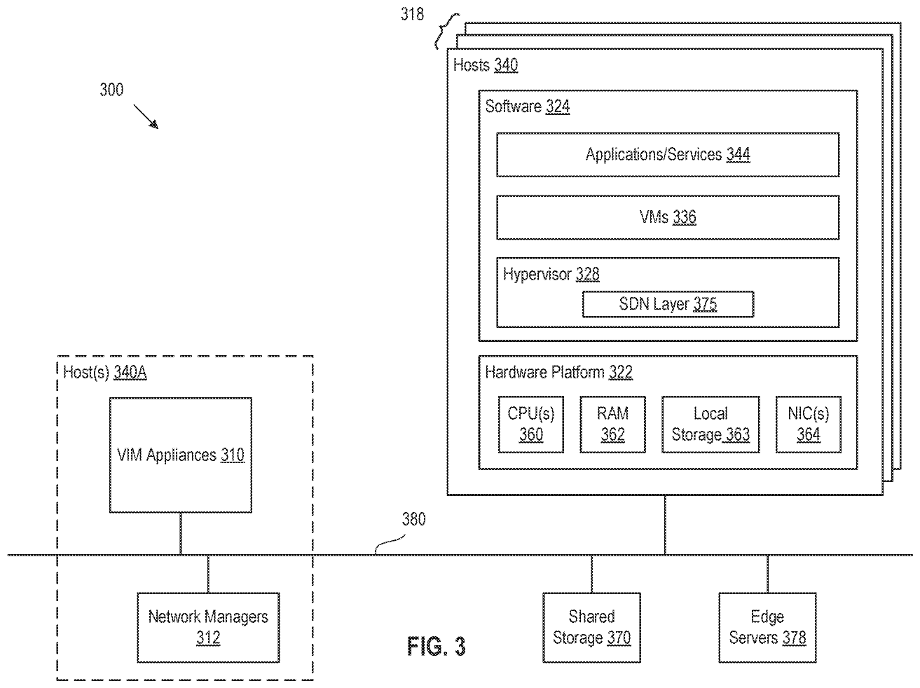

FIG. 1 is a block diagram depicting a virtualized computing system 100 according to embodiments. Virtualized computing system 100 includes a cloud platform 12 in a public cloud 10. Cloud platform 12 includes software executing on virtualized infrastructure of public cloud 10, such as virtual machines (VMs) and/or containers executing on virtualized host computers (“hosts”). Example virtualized infrastructure is shown in FIG. 3. The software of cloud platform 12 includes cloud services 18. A user interface (UI) or an application programming interface (API) that interacts with cloud services 18 are depicted in FIG. 1 as UI 14 and API 16, respectively. A user can interact with cloud services 18 through UI 14 and/or API 16. Software can interact with cloud services 18 through API 16.

The user can be a customer of public cloud 10 or part of an organization that is a customer of public cloud 10 (e.g., public cloud is managed by a service provider). UI 14 can be a separate software component from cloud services 18. Alternatively, all or a portion of UI 14 can be part of one or more of cloud services 18. Likewise, API 16 can be part of a separate software component from cloud services 18. Alternatively, all or a portion of API 16 can be part of one or more of cloud services 18.

Cloud platform 12 is connected to software components (“components”), which can include user cloud services 20 executing in public cloud 10, multi-tenant service 36 executing in public cloud 10, SDDCs 28 in a public cloud 24, and/or software 32, 34, 38 executing in data center(s) 26 of an on-premises environment 27. User cloud services 20 comprise cloud services, separate from cloud platform 12, provided to the user by public cloud 10 (e.g., software-as-a-service (SaaS) products). SDDCs 28 can be deployed on virtualized infrastructure of public cloud 24 to which the user subscribes or purchases (e.g., SDDCs deployed on infrastructure-as-a-service (IaaS) products or bring-your-own-hardware (BYOH) products). Software 32, 34, 38 executes on virtualized infrastructure in data center(s) 26 owned and operated by the user (e.g., virtualization management software, network management software, hypervisors, etc.). Multi-tenant service 36 manages software, such as software 34 in data center(s) 26, having instances executed by multiple tenants (e.g., the user is one tenant; software of other tenants is omitted for clarity). Public cloud 10, public cloud 24, and data center(s) 26 are connected by wide area network (WAN) 25 (e.g., the public Internet). Cloud platform 12 connects to SDDCs 28 and software 32, 34, and 38 through WAN 25. Cloud platform 12 connects to user cloud services 20 and multi-tenant service 36 through a network of public cloud 10 (not shown). Public cloud 24 can be separate from public cloud 10 (e.g., public clouds 10 and 24 have different service providers).

Cloud services 18 include deployment service 50, subscription service 52, and entitlement service 54. Cloud platform 12 includes cloud storage 17 for use by cloud services 18 to store their persistent data (e.g., database(s)). Cloud storage 17 can be any type of persistent storage. A user or software interacts with subscription service 52 through UI 14 or API 16 to obtain subscriptions for components (e.g., user cloud services 20, SDDCs 28, software 32, 34, 38). The user can purchase subscriptions according to any business model. Each subscription includes a software license (“license”) to enable a set of features of one or more components. Subscription service 52 notifies deployment service 50 of subscriptions obtained by the user.

Deployment service 50 generates entitlement tasks based on the subscriptions. An entitlement task includes an instruction to entitlement service 54 to entitle target component(s) based on a subscription. Entitlement service 54 consumes entitlement tasks generated by deployment service 50. Entitlement service 54 performs each entitlement task according to different modes, as discussed below. For each entitlement task, entitlement service 54 generates an entitlement specification to be applied to the target component(s). An entitlement specification dictates enablement of a set of features for each target component.

Components have associated licensing endpoints. The licensing endpoints are configured to apply the entitlement specifications to their respective components. A licensing endpoint can be a part of the component (e.g., a license manager API of the component) or can be a separate service from the component (e.g., a license manager service). In the example of FIG. 1, a user cloud service 20 includes a license manager (LM) 62; an SDDC 28 includes an LM 60; software 32 includes an LM 66; software 34 includes an LM 64; and software 38 includes an LM 68. LMs 62, 64, and 66 are part of their respective components (e.g., LM APIs). LM 68 comprises an LM service separate from software 38. LM 60 can also be an LM service executing in SDDC 28. LMs 60, 62, 64, 66, and 68 comprise licensing endpoints in virtualized computing system 100. Entitlement service 54 delivers entitlement specifications to licensing endpoints for application to their respective components (e.g., either directly or through a proxy, as described below).

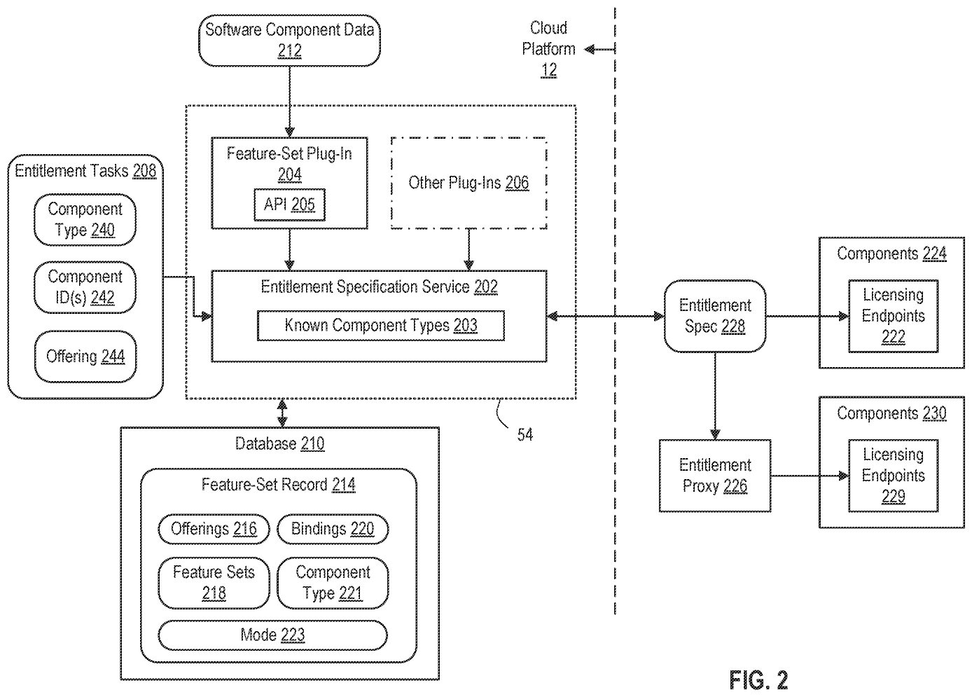

FIG. 2 is a block diagram depicting logical operation of entitlement service 54 in cloud platform 12 according to embodiments. Entitlement service 54 comprises an entitlement specification service 202 and a feature-set plug-in 204. Entitlement specification service 202 consumes entitlement tasks 208 and generates entitlement specifications 228 to be applied to components, e.g., components 224 and 230. Entitlement specification service 202 is agnostic with respect to component type and component feature set. That is, entitlement specification service 202 has no dependency on any particular component types or component feature sets, but rather can entitle any component type with which entitlement service 54 is made aware through feature-set plug-in 204.

Feature-set plug-in 204 includes an API 205. An operator (a human user or software) interacts with feature-set plug-in through API 205 to provide software component data 212 as input and create/update feature-set records 214. An operator can also delete feature-set records 214 through API 205. Feature-set plug-in 204 stores feature-set records 214 in database 210. A feature-set record 214 includes a component type 221, offerings 216, feature sets 218, and bindings 220. A component includes any number of features that provide different functionalities. A provider licenses a component through offerings 216. An offering 216 includes a feature set 218 to be licensed and enabled (associated through a binding 220). A provider can define several offerings 216 (e.g., base edition, enterprise edition, complete edition, etc.) each having different feature sets 218 (e.g., less features in the base edition as compared to the complete edition). Component type 221 can be a name, version, and the like. For example, a component can be a virtualization management server and component type 221 can be a product name and version of the virtualization management server. An operator can also set a mode 223 in feature-set record 214, which determines how entitlement specification service 202 delivers entitlement specifications to components of component type 221.

The operator creates feature-set records 214 for the various component types to be supported by entitlement service 54. Feature-set plug-in 204 notifies entitlement specification service 202 of component type 221 in each feature-set record 214 stored in database 210. Entitlement specification service 202 maintains a list of known component types 203 and accepts connections from components having a known component type 203. Entitlement specification service 202 can deny a connection from any component have a type that is not known to entitlement specification service 202.

Each entitlement task 208 includes a component type 240, component ID(s) 242, and an offering 244. Upon consuming an entitlement task 208, entitlement specification service 202 queries feature-set plug-in 204 using API 205 with component type 240 and corresponding offering 244. Feature-set plug-in 204 retrieves a feature-set record 214 having component type 221 that matches component type 240. Feature-set plug-in 204 identifies offering 216 that matches offering 244 and identifies a corresponding feature set 218 through a binding 220. Feature-set plug-in 204 returns a feature-set 218 to entitlement specification service 202 as a result of the query. Feature-set plug-in 204 can also return mode 223. Entitlement specification service 202 generates an entitlement specification 228 that enables feature set 218 for components of component type 240 having component ID(s) 242. Entitlement specification service 202 delivers entitlement specification based on mode 223.

In embodiments, mode 223 can specify one or both of two modes: push and pull. In the push mode, entitlement specification service 202 delivers entitlement specification 228 based on a connection made by component 224. A component 224 connects to entitlement service 202 and announces its component type and component ID. Entitlement specification service 202 accepts the connection if the component type is a known component type 203. If the component's component ID matches an entitlement specification 228, entitlement specification service 202 provides the entitlement specification to its licensing endpoint 222. In the pull mode, the entitlement specification service 202 receives an entitlement request from a requester, which can be the component itself, a licensing endpoint for a component, or an entitlement proxy 226 (e.g., multi-tenant service). The entitlement request includes component ID(s) and component type and entitlement specification service 202 returns a respective entitlement specification 228 to the requester. Entitlement proxy 226, as a requester, can deliver entitlement specification 226 to a licensing endpoint 229 of each component 230.

The decoupling of feature sets from a generic entitlement specification service that provides entitlement specifications can be applied to other entitlement techniques using other plug-ins 206. For example, a metering plug-in can decouple software metering from entitlement specification service 202.

FIG. 3 is a block diagram depicting virtualized infrastructure 300 according to embodiments. Virtualized infrastructure 300 or variants thereof can be used to support cloud platform 12, SDDCs 28, and on-premises software shown in FIG. 1. Virtualized infrastructure 300 includes a cluster of hosts 340 (“host cluster 318”) that may be constructed on hardware platforms such as an x86 architecture platforms or ARM platforms. For purposes of clarity, only one host cluster 318 is shown. However, virtualized infrastructure 300 can include many of such host clusters 318. As shown, a hardware platform 322 of each host 340 includes conventional components of a computing device, such as one or more central processing units (CPUs) 360, system memory (e.g., random access memory (RAM) 362), one or more network interface controllers (NICs) 364, and optionally local storage 363. CPUs 360 are configured to execute instructions, for example, executable instructions that perform one or more operations described herein, which may be stored in RAM 362. NICs 364 enable host 340 to communicate with other devices through a physical network 380. Physical network 380 enables communication between hosts 340 and between other components and hosts 340.

In the embodiment illustrated in FIG. 3, hosts 340 access shared storage 370 by using NICs 364 to connect to network 380. In another embodiment, each host 340 contains a host bus adapter (HBA) through which input/output operations (10s) are sent to shared storage 370 over a separate network (e.g., a fibre channel (FC) network). Shared storage 370 include one or more storage arrays, such as a storage area network (SAN), network attached storage (NAS), or the like. Shared storage 370 may comprise magnetic disks, solid-state disks, flash memory, and the like as well as combinations thereof. In some embodiments, hosts 340 include local storage 363 (e.g., hard disk drives, solid-state drives, etc.). Local storage 363 in each host 340 can be aggregated and provisioned as part of a virtual SAN, which is another form of shared storage 370.

Software 324 of each host 340 provides a virtualization layer, referred to herein as a hypervisor 328, which directly executes on hardware platform 322. In an embodiment, there is no intervening software, such as a host operating system (OS), between hypervisor 328 and hardware platform 322. Thus, hypervisor 328 is a Type-1 hypervisor (also known as a “bare-metal” hypervisor). As a result, the virtualization layer in host cluster 318 (collectively hypervisors 328) is a bare-metal virtualization layer executing directly on host hardware platforms. Hypervisor 328 abstracts processor, memory, storage, and network resources of hardware platform 322 to provide a virtual machine execution space within which multiple virtual machines (VM) 336 may be concurrently instantiated and executed. Applications and services 344 execute in VMs 336 (e.g., including containerized services).

Host cluster 318 is configured with a software-defined (SDN) layer 375. SDN layer 375 includes logical network services executing on virtualized infrastructure in host cluster 318. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized infrastructure 300 includes edge servers 378 that provide an interface of host cluster 318 to WAN 25.

A VIM appliance 310 is a non-virtualized or virtual server that manages host cluster 318 and the virtualization layer therein. VIM appliance 310 installs agent(s) in hypervisor 328 to add a host 340 as a managed entity. VIM appliance 310 logically groups hosts 340 into host cluster 318 to provide cluster-level functions to hosts 340, such as VM migration between hosts 340 (e.g., for load balancing), distributed power management, dynamic VM placement according to affinity and anti-affinity rules, and high-availability. The number of hosts 340 in host cluster 318 may be one or many. VIM appliance 310 can manage more than one host cluster 318. Virtualized infrastructure 300 can include more than one VIM appliance 310, each managing one or more host clusters 318.

In an embodiment, virtualized infrastructure 300 further includes a network manager 312. Network manager 312 (another management appliance) is a non-virtualized or virtual server that orchestrates SDN layer 375. In an embodiment, network manager 312 comprises one or more virtual servers deployed as VMs. Network manager 312 installs additional agents in hypervisor 328 to add a host 340 as a managed entity. In embodiments, VIM appliances 310 and network managers 312 execute on hosts 340A, which are selected ones of hosts 340 and which form a management cluster.

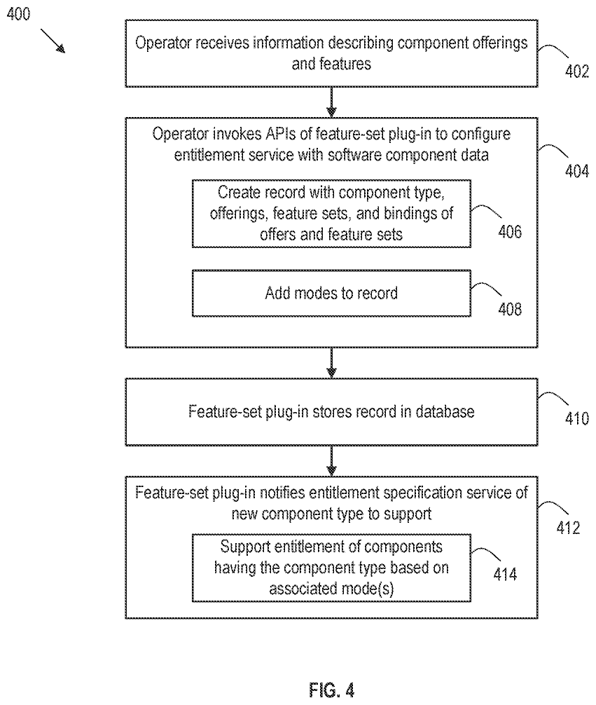

FIG. 4 is a flow diagram depicting a method 400 of configuring an entitlement service that manages entitlement of software in a virtualized computing system according to embodiments. Method 400 begins at step 402, where an operator receives information describing component offering and features (e.g., from a provider of the component). At step 404, operator invokes APIs 205 of feature-set plug-in 204 to configure entitlement service 54 with software component data 212. This includes, at step 406, creating a feature-set record 214 with a component type 221, offerings 216, feature sets 218, and bindings 220 between offerings and feature sets. At step 408, the operator can add a mode or modes 223 to feature-set record 214. At step 410, feature-set plug-in 204 stores feature-set record 214 in database 210. At step 412, feature-set plug-in notifies entitlement specification service 202 of a new component type 221 to support. This includes, at step 414, supporting entitlement of components having component type 221 based on its associated mode(s) 223.

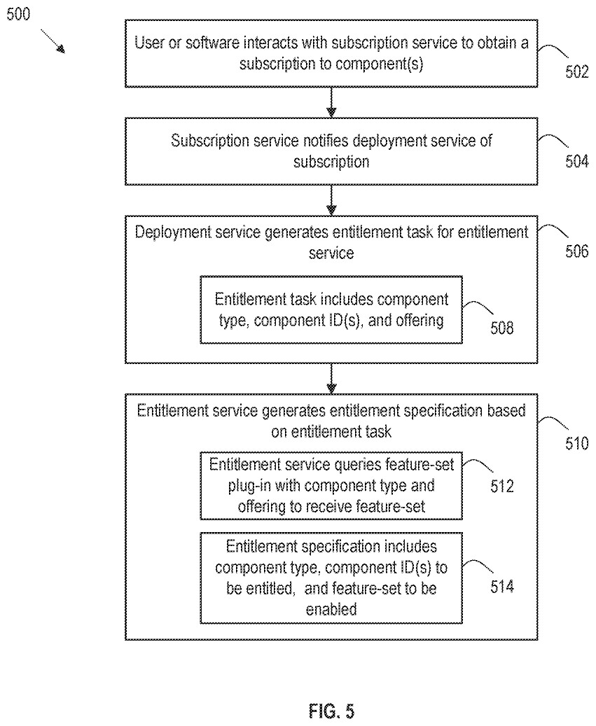

FIG. 5 is a flow diagram depicting a method 500 of processing a subscription to software component(s) according to embodiments. Method 500 begins at step 502, where a user or software interacts with subscription service 52 to obtain a subscription to component(s). The subscription includes a license for component(s) having component ID(s) and for an offering that enables a set of features. At step 504, subscription service 52 notifies deployment service 50 of the subscription. At step 506, deployment service 50 generates an entitlement task 208 for entitlement service 54. Entitlement task 208 includes a component type 240, component ID(s) 242 to be entitled, and an offering 244 (508). At step 510, entitlement service 54 consumes entitlement task 208 and generates an entitlement specification 228. This includes, at step 512, entitlement service 52 querying feature-set plug-in 204 with component type and offering to receive a corresponding feature set. Entitlement specification 228 includes component type, component ID(s) to be entitled, and the feature-set to be enabled (514).

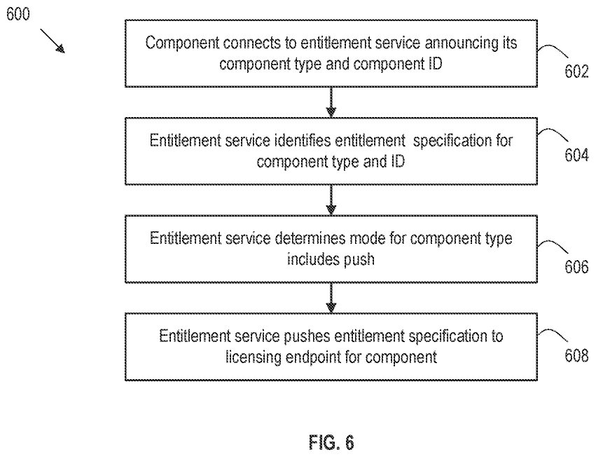

FIG. 6 is a flow diagram depicting a method 600 of entitling a component in a virtualized computing system according to embodiments. Method 600 begins at step 602, where a component 224 connects to entitlement service 54 announcing its component type and component ID. At step 604, entitlement service 54 identifies an entitlement specification 228 for the component based on its type and ID. At step 606, entitlement service 54 determines that the mode for component type includes push. At step 608, entitlement service 54 pushes entitlement specification 228 to a licensing endpoint 222 for component 224.

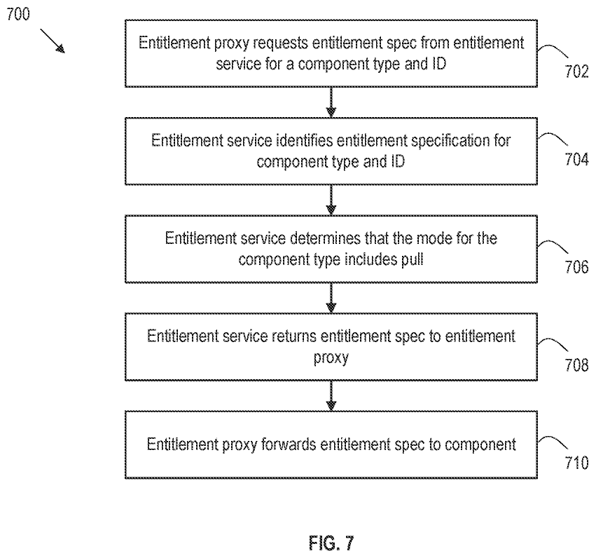

FIG. 7 is a flow diagram depicting a method 700 of entitling a component in a virtualized computing system according to further embodiments. Method 700 begins at step 702, where entitlement proxy 226 requests entitlement specification 228 from entitlement service 54 for a component type and component ID. At step 704, entitlement service 54 identifies entitlement specification 228 for the component type and component ID. At step 706, entitlement service determines that the mode for the component type includes pull. At step 708, entitlement service returns entitlement specification 228 to entitlement proxy 226. At step 710, entitlement proxy forwards entitlement specification 228 to component 230 (e.g., a licensing endpoint 229 for component 230).

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of configuring an entitlement service that manages entitlement of software in a virtualized computing system, the method comprising:
receiving, at a plug-in of the entitlement service, software component data that specifies a component type and offerings of the component type, the offerings associated with feature sets, the entitlement service executing on a cloud platform in the virtualized computing system;
storing, by the plug-in, the software component data in a database; and
notifying, by the plug-in, the entitlement service to support entitlement of components of the software having the component type.

2. The method of claim 1, wherein the entitlement service supports entitlement of the components by pushing entitlement specifications to the components, each entitlement specification generated in response to an offering of the software component data, each entitlement specification dictating enablement of a feature set of the software component data associated with the offering.

3. The method of claim 2, wherein pushing the entitlement specifications to the components comprises sending the entitlement specifications to licensing endpoints configured to apply the entitlement specifications to the components.

4. The method of claim 1, wherein the entitlement service supports entitlement of the components by receiving requests for entitlement specifications for the components, each entitlement specification generated in response to an offering of the software component data, each entitlement specification dictating enablement of a feature set of the software component data associated with the offering.

5. The method of claim 4, wherein receiving the requests for the entitlement specifications comprises receiving the requests from proxies executing on behalf of the components, the proxies configured to send the entitlement specifications to licensing endpoints configured to apply the entitlement specifications to the components.

6. The method of claim 1, wherein the software component data includes a mode for the component type, the mode configuring the entitlement service to either push entitlement specifications to the components upon connection or send entitlement specifications in response to requests.

7. The method of claim 1, wherein the entitlement service includes an entitlement specification service configured to support the entitlement of the components of the software, the entitlement specification service being agnostic to component types of the software.

8. A method of entitling software in a virtualized computing system, comprising:
receiving, at an entitlement service executing on a cloud platform in the virtualized computing system, an entitlement task that includes a component type and an offering of the component type, the component type being a type of component of the software;
querying, by the entitlement service, a plug-in of the entitlement service with the component type and the offering to receive a feature set; and
entitling, by the entitlement service, a target component of the software having the component type using an entitlement specification that dictates enablement of the feature set on the target component.

9. The method of claim 8, wherein the step of entitling comprises:
receiving, at the entitlement service, a connection by the target component; and
pushing, in response to the connection, the entitlement specification from the entitlement service to a licensing endpoint configured to apply the entitlement specification to the target component.

10. The method of claim 8, wherein the step of entitling comprising:
receiving, at the entitlement service, an entitlement request; and
sending, in response to the request, the entitlement specification for application to the target component.

11. The method of claim 10, wherein the entitlement request is received from a proxy executing on behalf of the target component, and wherein the entitlement service sends the entitlement specification to the proxy.

12. The method of claim 8, further comprising:
receiving, at the cloud platform, input to select a subscription for the target component, the subscription including a license for the offering of the component type; and
generating, by the cloud platform, the entitlement task in response to the subscription.

13. The method of claim 12, wherein the subscription includes a component identifier (ID) associated with the target component, and wherein the entitlement task further includes the component ID.

14. The method of claim 13, wherein the step of entitling comprises:
receiving, at the entitlement service, a connection by the target component, the target component providing the component type and the component ID with the connection;
pushing, in response to the target component having the component type and the component ID, the entitlement specification from the entitlement service to a licensing endpoint configured to apply the entitlement specification to the target component.

15. A computer system, comprising:
a cloud platform executing in a public cloud;
software executing on hardware of the computer system;
an entitlement service executing on the cloud platform, the entitlement service configured to:
receive, at a plug-in thereof, software component data that specifies a component type and offerings of the component type, the offerings associated with feature sets;
store, by the plug-in, the software component data in a database; and
notify, by the plug-in, an entitlement specification service to support entitlement of components of the software having the component type.

16. The computer system of claim 15, wherein the entitlement service is configured to:
receive an entitlement task that includes the component type and an offering of the software component data;
query the plug-in with the component type and the offering to receive a feature set of the software component data; and
entitle a target component of the software having the component type using an entitlement specification that dictates enablement of the feature set on the target component.

17. The computer system of claim 16, wherein the entitlement service is configured to entitle the target component by:
receiving, at the entitlement service, a connection by the target component; and
pushing, in response to the connection, the entitlement specification from the entitlement service to a licensing endpoint configured to apply the entitlement specification to the target component.

18. The computer system of claim 16, wherein the entitlement service is configured to entitle the target component by:
receiving, at the entitlement service, an entitlement request; and
sending, in response to the request, the entitlement specification for application to the target component.

19. The computer system of claim 18, wherein the entitlement request is received from a proxy executing on behalf of the target component, and wherein the entitlement service sends the entitlement specification to the proxy.

20. The computer system of claim 15, wherein the entitlement specification service is agnostic to component types of the software.
